(19) United States
(12) Patent Application Publication
(10) Pub. No.: US 2002/0029790 A1
(43) Pub. Date: Mar. 14, 2002

(54) Method and device for cleaning the rubber cylinders of printing presses

(76) Inventors: Marco Corti, Lecco (IT); Riccardo Fumagalli, Oggiono (IT)

Correspondence Address: LARSON & TAYLOR, PLC, 1199 NORTH FAIRFAX STREET, SUITE 900, ALEXANDRIA, VA, 22314, US

(21) Appl. No.: 09/859,525

(22) Filed: May 18, 2001

(30) Foreign Application Priority Data
May 19, 2000 (IT) BO2000 A 000302

(51) Int. Cl. B08B 3/02

(52) U.S. Cl. 134/6; 134/33; 134/153; 134/36; 15/256.51; 101/425

(57) ABSTRACT

The method for cleaning the rubber cylinders of printing presses particularly of the so-called bobbin type, comprises the succession of the following working phases:

Uniformly distributed and preferably continuous atomisation onto each cylinder to be cleaned, which rotates continuously, of a fluid cleaning mixture formed by compressed air and by one or more cleaning liquids, in such a manner that the liquid involves the cylinder with very small drops distributed according to a dot mapping, of discrete type and which varies during the time.

Maintaining of said atomisation phase for a predetermined time, while the cylinder performs one or more rotations with respect to the zone of atomisation of the cleaning mixture.

Doctor scraping of the cylinder downstream of the atomisation zone, in order to remove the dirt diluted by the said fluid cleaning mixture.

### DESCRIPTION

The invention relates particularly to the industrial printing presses of the bobbin type of the last generation, provided with rubber cylinders which are deprived or substantially deprived of peripheral interruptions and, for this type of machines it concerns to a new method and relating device or apparatus for the cleaning of said cylinders.

The cleaning of rubber cylinders is presently effected by devices which comprise a cloth pushed by a presser against the cylinder and onto which there are sprayed cleaning liquids, or which comprise a cylindrical and rotary brush, which is brought to parallelly interfere with the cylinder and which upstream and downstream of its contact zone with the said cylinder is respectively sprayed with cleaning liquids and is brought into co-operation with cleaning means. These devices are complex from the constructional point of view, they present parts which are subject to wear so that they must be periodically services and are comparatively expensive.

For the cleaning of the rubber cylinders of printing presses, there are also known devices which are more simple and economical than those previously described, provided with a bar which upon control sprays cleaning liquid onto the cylinders which are not inked are and maintained in rotation an under pressure against the continuous paper ribbon which is used as a means for the continuous cleaning of the said cylinders. This mode of operating operates correctly whenever the dirt accumulated on the cylinders is comparatively fresh and of limited thickness, while whenever the dirt presents a substantial thickness, there is the danger that same form with the cleaning liquid a sort of tacky mixture which has the tendency of fixing itself to the paper and to tear it, thus interrupting the continuity of the cleaning ribbon. This system presents then the limitation of cleaning the cylinders only for the portion of width interested by the continuous paper ribbon and not also for the end portions onto which there is the tendency during the time of an accumulation of ink and dirt.

In order to clean the rubber cylinders of printing presses on continuous paper ribbon unreeled from a bobbin, the invention proposes a new method and a relative device which consent to operate both on the machine under operation, with the cylinders which rotate in contact with the paper ribbon to be printed, and on the machine at rest, without the presence of the paper ribbon between the cylinders to be cleaned. The device according to the invention comprises a bar with nozzles capable of atomising finely, uniformly and continuous on the cylinder a mixture formed by air under pressure and of detergent liquids. On the forward front of the said bar there is provided a chamber which is open in the direction of the cylinder and is provided with a lower projecting edge, parallel to the cylinder itself and shaped so as to operate as a doctor. Each cylinder is provided with such a cleaning device or apparatus. If the printing press is at rest, there is effected a first phase of atomisation of the said mixture of air and liquid onto the cylinders, so that these are wetted a uniformly distributed and continuous manner, which the said cylinders are brought into rotation and are preferably pressed the one against the other, so that in the zone of reciprocal contact of the cylinders the layer of dirt is cracked and that into the dirt itself there is pushed the cleaning liquid which can therefore solve the said dirt in a deep manner in and limited times. After this phase, which has a predetermined duration, the device is further brought near to the relating cylinder, so that is front doctor removes the dirt solved in the previous phase. During this phase the nozzles remain preferably active so as to further dilute the dirt removed by the doctor, to render it more fluid and to facilitate its discharge, and also to maintain the cylinder always suitably lubricated and protected. The said cycle can be repeated several times, up to the complete cleaning of the cylinders along their whole extension, also on the end zones which are externals to the sones which normally operate in contact with the paper ribbon to be printed.

If instead the printing press in operative conditions, its is avoided that the cylinders to be cleaned are inked and the device is employed to uniformly and continuously atomise on the said cylinder the fluid cleaning mixture, on order to solve the dirt which is progressively removed by the paper, as in the known prior art, with the difference that the wetting of the cylinder is now effected gradually, in a uniformly distributed and continuous manner, so as to avoid localised concentrations of liquid which could tear the paper sheet as it happens in the known technique. Also in this case there can be foreseen the cyclical or final intervention of the doctor, in order to improve the cleaning of the said cylinders also in the end zones located at the exterior of the paper ribbon, on which zones there is the unavoidable tendency to have accumulations of dirt and cleaning liquid.

The fluid cleaning mixture which is atomised on the cylinders can present a concentration of liquid which is constant or which can vary during the cleaning cycle.

Further characteristic features of the invention, and the advantages deriving therefrom, will appear better evident from the following description of a preferred embodiment of same, made merely by way of non-limiting example in the figures of the attached sheet of drawings, in which:

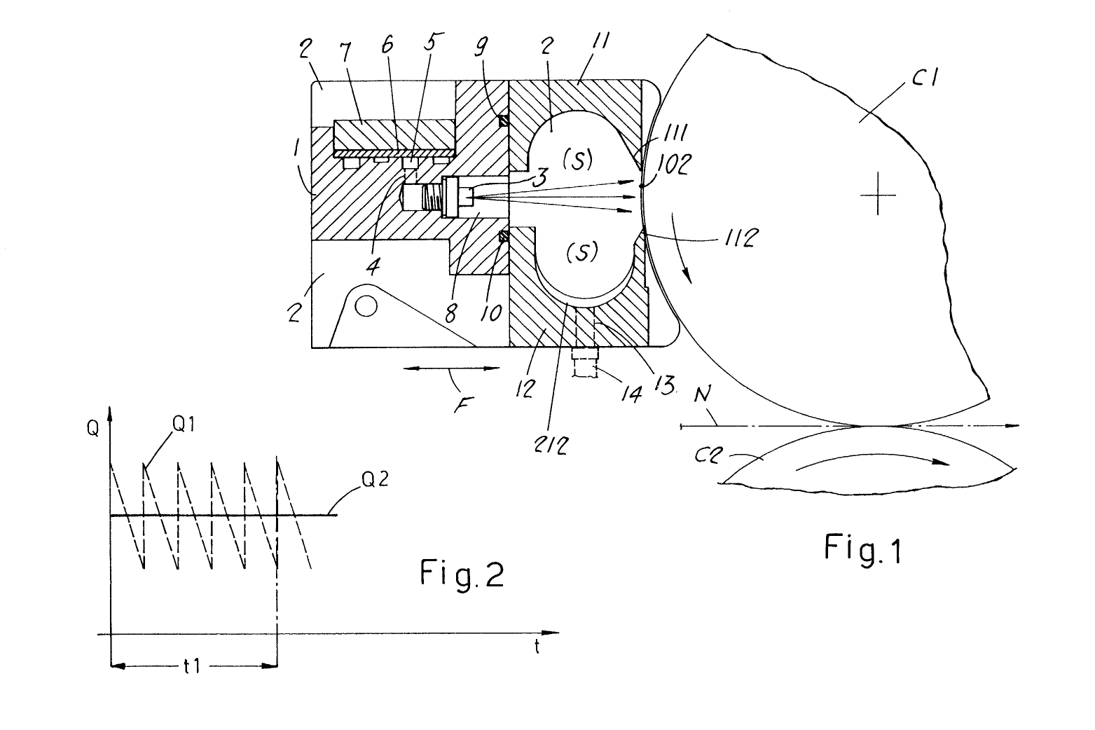

FIG. 1 shows a possible practical realisation of the apparatus or device according to the invention, taken in its condition of cleaning of one of the rubber cylinders of a printing press of the so-called bobbin type;

FIG. 2 is a graph which diagrammatically evidences the mode of operation of the apparatuses of known type and of the apparatus according to the invention.

In FIG. 1, reference letters C1 and C2 indicate partially the rubber cylinders to be cleaned, between which there passes (or not) the continuous paper ribbon N to be printed (see after). Parallelly to each cylinder there is provided a cleaning apparatus or device arranged at the left of cylinder C1 which is supposed to rotate in anti clockwise direction and arranged instead at the right of cylinder C2 which rotates in clockwise direction. The cleaning apparatuses are identical so that, for the sake of simplicity, we will now described only the one associated with cylinder C1. The apparatus comprises parallelly to the cylinder a bar 1 secured by its extremities to shoulders 2 connected to means for displacing same, not shown, which upon control move near or move away the apparatus to and from the cylinder to be cleaned, as diagrammatically indicated by the arrows F. On the front side of the bar 1 which is directed towards cylinder C1 there is mounted, preferably at the interior of a longitudinal channel 8, a row of atomising nozzles 3 which are perpendicular to said cylinder, in such a number and with such an arrangement so as to involve the said cylinder in a uniform manner and substantially for its whole length. As described in Italian patent IT 1 286 206 (corresponding to EP 0 916 492) and in the patent application PCT/EP 01/00267 in the name of the same applicants, the nozzles 3 are for example connected by means of bores 4 to channels 5 obtained by milling onto a flat face of the bar 1 onto which there is thereafter laid a flat packing 6 and there is fixed by means of screws, not shown, a cover plate 7 which transforms the said canalisations or channels into proper ducts. The said channels are connected in symmetrical manner to other feed channels which branch off between each other, which connect reciprocally two by two with Y bifurcations and progressively are reduced by number until they meet together into a single feed duct for the cleaning fluid mixture composed of air under pressure and of one or more detergent liquids (water and solvents) opening into an orifice arranged for example at one extremity of the bar 1. Each Y-shaped bifurcation of the said channels is obtained along a straight path and the ducts resulting from the bifurcation are structured in such a manner as to offer a substantially equal resistance to the flow of the fluid mixture, so that this latter is divided in substantially equal quantities at each bifurcation. The bifurcations are in such a number that each final duct resulting from a bifurcation, feeds one single nozzle, so as to ensure a balanced distribution of the cleaning fluid mixture between the various nozzles of the apparatus. By this solution it is possible to ensure a controlled and continuous feeding of cleaning fluid onto the cylinder 1 so as to wet same in uniformly distributed manner with water and/or with solvent.

In the example according to the invention, the bar 1 has substantially a profile like a T rotated of ninety degrees and on the front directed towards the cylinder C1, above and below the groove or channel 8 it carries, in close contact and preferably secured , with the interposition of suitable sealing means 9 and 10, the grooved and opposed bodies 11 and 12 which at their extremities are closed by the shoulders 2. Both the bodies 11, and 12 or at least the lower body 12 are preferably firmly secured to the shoulders 2 by any suitable means. The shoulders 2 are located beyond the length of the useful surface of the cylinder to be cleaned and their front directed towards the cylinder is suitable curved as indicated by reference numeral 102 so that whenever the cleaning apparatus is brought in its active run for cleaning the cylinder itself, the said front comes to be located at a short distance from the metallic end crowns of the said cylinder, or it touches the said crowns if it is made or coated with a suitable self-lubricating material (see after).

The upper grooved body 11 is suitably arranged in a backward position with respect to the curved front 102 of the shoulders 2, while the lower grooved body 12 presents its forward edge 112 with a wedge-shaped profile, tapered towards the top and the sharp edge of which is rounded and it projects beyond said front 102 so as to form a doctor capable of uniformly touching the cylinder to be cleaned along its whole useful surface. The body 12 is made with any suitable material adapted for this purpose. It is in any case to be understood that the body 12 can be differently constructed in composite shape, with the edge 112 made as an insert which can be substituted if required.

The bottom of the grooved body 12 is preferably longitudinally inclined as indicated by 212 and at its lower extremity there is provided a discharge hole 13 connected with a discharge duct 14.

The opposed grooved bodies 11, 12 realise a chamber S closed at its extremities by the shoulders 2 and open in the direction of the cylinder to be cleaned, which has the function of exclusively directing towards the cylinder the atomisation effected by the nozzles 3.

The edge 111 of the upper grooved body 11, which is facing the cylinder to be cleaned, is preferably tapered and tangent to the inner cavity of said body, so as to discharge by gravity firstly onto the doctor 112 and then onto the cylinder, any drops of the cleaning liquid which are formed during the atomisation of the said liquid inside the above mentioned chamber S.

The described apparatus operates in the following manner.

If the printing press is at rest and the paper ribbon N does not pass between the cylinders C1 and C2, the cleaning apparatuses are brought near to the relating cylinder so as to result at a short distance therefrom, but the doctor edge 112 does not touch the cylinder itself. From the nozzles 3 there is atomised in a continuous and uniform manner the fluid cleaning mixture onto the cylinders C1, C2, while they rotate and they are preferably brought near the one against the other with a correct degree of pressure, so as to facilitate the penetration of the cleaning liquid into the dirt. This phase has a predetermined time duration, necessary in order that the cylinders effect one or more rotations and such to sufficiently soften the dirt. After this phase the cleaning apparatuses according to the invention are brought near to the respective cylinders as illustrated in FIG. 1 of the drawing, so that the doctor 112 removes the dirt which was softened in the previous phase. The degree of interference of the doctor with the cylinder is controlled by the contact of the fronts 102 of the shoulders 2 with the end crowns of the cylinder, or by end-of-stroke means, not shown, which limit the active run of the cleaning apparatuses. During this phase, the nozzles 3 preferably continue to atomise the cleaning fluid, in order to protect the cylinder during the scraping, and to further fluidify the removed dirt which falls into the body 12 and is discharged through the duct 14. The doctor scraping phase will last at least for the time required to the cylinder being cleaned for effecting a full rotation, after which the cleaning apparatus is moved away and the described cycle is repeated until the cylinder is completely cleaned. If the cylinders are not much dirty, a single cleaning cycle can be sufficient.

It is to be understood that between the cylinder wetting phase and the scraping phase there can be provided an intermediate phase during which the cylinders continuously rotate and which consents to the atomised liquid to react onto the dirt to be removed.

If instead the printing press is in operation, with the paper ribbon N passing between the cylinders C1, C2 in the normal pressure condition on said ribbon, the cleaning devices are brought near to the respective cylinders without touching them with the doctors 112, but only for atomising continuously and uniformly the cleaning fluid onto the said cylinders which during this phase obviously are not inked and which successively are cleaned by the contact with the paper N. In this manner there are avoided the inconveniences of the known prior art, since there are avoided localised accumulations of water and/or solvent on the cylinders.

Also in this case however, during the overall cleaning cycle of the active cylinders, there is foreseen that the cleaning apparatuses be temporarily brought near to the cylinders so as to touch them with the doctors 112, in order to obtain a finishing operation and above all to remove that dirt which involves the end zones of the said cylinders, which are not concerned by the paper ribbon and which thus would risk to remain dirty. Also during this phase the nozzles 3 remain active in order to ensure a suitable lubrication and protection of the cylinder to be cleaned.

The cleaning liquids used, and particularly the solvents, are preferably of the low volatility type, in order to perform a dilution of the inks which is more energetic and which is time-lasting.

When the cleaning of the cylinders has been effected, the cleaning apparatuses return back to their rest position, at a correct distance from the said cylinders.

In the graph of FIG. 2 of the attached drawing, on the abscissa there are indicated the times “t” of the cleaning cycle of the cylinders, while on the ordinate there are indicated the quantities Q of cleaning liquid sprayed onto the cylinders. The curve indicated by Q1 and with dash lines represents the mode of operations of the known systems mentioned in the introductory portion of the present description. The peaks of this curve indicate the instants of spraying of the liquid, during which it is obtained the maximum concentration of cleaning liquid onto the cylinder to be cleaned. For example with five sprayings of liquid and in the time interval indicated by t1, there takes place the cleaning of a cylinder, while during the successive time there takes place the cleaning of a subsequent cylinder. According to the known prior art, in fact, the cylinders are cleaned one at a time, in order to exploit at the maximum the absorbent and cleaning power and the mechanical resistance of the paper ribbon which passes between the cylinders, to avoid the tearing of the said ribbon and to avoid excesses of solvent inside the subsequent drying oven of the said paper ribbon.

The line Q2 of the graph of FIG. 2, evidenced by continuous line, indicates instead the mode of operation of the apparatus according to the invention, which precisely provides for a continuous and uniformly distributed atomisation onto the cylinders to be cleaned, of a fluid cleaning mixture made of air under pressure and of detergent liquids. Differently from what happens in the known art, in the process according to the invention the cylinders C1 and C2 can be cleaned simultaneously. The atomisation of the cleaning liquid effected by the nozzles 3 of the apparatus according to the invention, is such that the liquid is deposited under the form of very small drops onto the surface of each cylinder, by wetting same in a uniformly distributed manner, but with a dot mapping, that is of reticular and discrete type, which varies during the time, so that to a dot which was wetted there can follow and/or be placed side by side a dry dot or viceversa. It is this condition which consents to operate continuously as indicated by the line Q1 and simultaneously on both cylinders C1 and C2, also in presence of the paper ribbon N between the said cylinders, since the ribbon will be now interested on both faces by very small quantities of dirt, uniformly distributed along the whole width of the ribbon itself.

It is to be understood that the continuous spraying of the fluid cleaning mixture effected by the nozzles 3 of the cleaning apparatuses, practically may not present the perfectly linear path indicated by the line Q2 of the graph of FIG. 2, since during different moments of the cleaning cycle, the mixture can be modified as for the quantity of liquid dispersed in the stream of air under pressure, and therefore will be more or less rich of liquid.

1) method for cleaning the rubber cylinders of printing presses particularly of the so-called bobbin type, characterised by the succession of the following working phases:
Uniformly distributed and preferably continuous atomisation onto each cylinder to be cleaned, which rotates continuously, of a fluid cleaning mixture formed by compressed air and by one or more cleaning liquids, in such a manner that the liquid involves the cylinder with very small drops distributed according to a dot mapping, of discrete type and which varies during the time.
Maintaining of said atomisation phase for a predetermined time, while the cylinder performs one or more rotations with respect to the zone of atomisation of the cleaning mixture.
Doctor scraping of the cylinder downstream of the atomisation zone, in order to remove the dirt diluted by the said fluid cleaning mixture.

2) Method according to claim 1, in which opposed cylinders (C1, C2) of the printing press are cleaned simultaneously.

3) Method according to claim 1, in which the quantity of liquid which composes the cleaning mixture atomised onto the cylinders is constant during the whole cleaning phase of the said cylinders.

4) Method according to claim 1, in which the fluid cleaning mixture can vary in its concentration during the cleaning cycle of the cylinders.

5) Method according to claim 1 in which the phase of atomisation of the cleaning fluid onto the cylinder is maintained also during the doctor scraping phase.

6) Method according to claim 1, characterised by the fact of being repeated more times in strict succession, up to the complete cleaning of the cylinders.

7) Method according to claim 1, characterised by the fact that in the absence of transit between the cylinders (C1, C2) to be cleaned of a continuous paper ribbon (N), there is provided, at least during the first phase of uniformly distributed and continuous wetting of the said cylinders with the atomised cleaning liquid, a phase of reciprocal compression of the said cylinders in order to facilitate the penetration of the detergent liquids into the dirt which covers the cylinders and which must be removed.

8) Method according to claim 7, characterised by the fact that between the initial phase of continuous and distributed wetting of the fluid cleaning mixture onto the cylinders and the last phase of doctor scraping of the said cylinders, there is provided for an intermediate phase during which the said first phase is interrupted and the cylinders continue their rotation for a time necessary for the detergent liquids to solve the dirt to be removed from the said cylinders.

9) Method according to claim 1, in which the cylinders to be cleaned are active and between them there passes a paper ribbon (N), characterised by the fact that the cleaning cycle is performed principally with a phase of atomisation of the fluid cleaning mixture onto the said cylinders which are not inked and which preferably operate with normal compression on the paper ribbon, and to said phase there can follow a final phase of doctor scraping of the cylinders, mainly for cleaning the said cylinders in the zones not interested by the said paper ribbon.

10) Method according to claim 1, characterised by the use of a cleaning mixture formed by compressed air and by low volatility detergent liquids.

11) Apparatus for cleaning the rubber cylinders of printing presses particularly of the so-called bobbin type, characterised by comprising, parallelly to each cylinder to be cleaned, a bar (1) secured by its ends to shoulders (2) connected to means for the parallel moving near and away of the said bar towards and away from said cylinder, on the front of the bar directed against the cylinder there being provided at least one row of nozzles which are directed perpendicularly to the said cylinder, apt for atomising in a fine and uniform manner onto same the cleaning fluid, and on the same front of the bar which carries the nozzles there being secured, above and below the row of the said nozzles, grooved and opposed bodies (11, 12), directed one against the other by their concave portions, so as to realise a chamber (S) closed at its extremities by the said shoulders (2) of the apparatus and which is open towards the cylinder, which has the function of conveying against the said cylinder the atomised mixture from the said nozzles, the more projecting edge (112) of the lower grooved body (12) being characterised by a wedge shaped profile, tapered upwardly, with rounded upper sharp edge and such as to touch the cylinder to be cleaned in order to perform the doctor scraping whenever the apparatus is brought near to the cylinder, while the upper grooved body remains in close proximity to the cylinder, without touching same.

12) Apparatus according to claim 11, in which the degree of interference of the doctor edge (112) of the lower grooved body (12) with the cylinder to be cleaned is controlled by the abutment of the said apparatus against means which stop its active run.

13) Apparatus according to claim 11, in which the degree of interference of the doctor edge (112) of the lower grooved body (12) with the cylinder to be cleaned is controlled by the abutment of the forward curved front (102) of the shoulders (2) of the said apparatus against the end crowns of the said cylinder, not interested by the rubber, the said front of the shoulders being coated with suitable low friction coefficient material.

14) Apparatus according to claim 11, in which the forward edge (111) of the upper grooved body (11) presents a profile which is tapered downwardly and is arranged in such a manner as to drip, onto the doctor (112) of the grooved body or onto the cylinder to be cleaned, possible deposits of the cleaning mixture atomised on the cylinder itself.

15) Apparatus according to claim 11, in which the grooved bodies (11, 12) are united and if the case secured onto the forward front of the bar (1) with the nozzles (3), with the interposition of packings (9, 10) and both bodies or at least the lower body are secured to the end shoulders (2).

16) Apparatus according to claim 11, in which the lower grooved body may present the doctor (112) as an insert which can be substituted.

17) Apparatus according to claim 11, in which the bottom (112) of the lower grooved body (12) is longitudinally inclined and at its lower point it is provided with an orifice (13) connected to a duct (14) for discharging the dirt removed fron the cylinder during the cleaning phase.

18) Apparatus according to claim 11, in which the nozzles are housed in a longitudinal channel (8) of the bar (1).

19) Apparatus according to claim 11, in which the nozzles (3) are connected to a respective channel (5) obtained in the rectilinear bar (1) which carries the said nozzles and which on its turn is connected in a symmetrical manner to other channels branching off from each other, which connect two by two with Y bifurcations and progressively are reduced in number until the unite into a single feeding duct for the fluid cleaning mixture, so as to ensure a balanced distribution of the said mixture between all the nozzles of the dispensing bar.
